(19) United States
(12) Patent Application Publication
(10) Pub. No.: US 2005/0036654 A1
(43) Pub. Date: Feb. 17, 2005

(54) Scanner and method for encrypting/decrypting documents by using the scanner

(76) Inventor: Cai-Xia Wan, SuZhou City (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/916,999

(22) Filed: Aug. 12, 2004

(30) Foreign Application Priority Data
Aug. 15, 2003 (TW) 092122579
Aug. 15, 2003 (CN) 03154321.9

(51) Int. Cl. G06K 9/00

(52) U.S. Cl. 382/100

(57) ABSTRACT

A method for encrypting/decrypting documents. The method includes the steps of: scanning a predetermined pattern; storing the predetermined pattern; scanning the documents; encrypting/decrypting the documents in accordance with the predetermined pattern.

This application claims the benefit of Taiwan application Serial No. 92122579, filed Aug. 15, 2003, the subject matter of which is incorporated herein by reference.

### BACKGROUND OF THE INVENTION

1. Field of the Invention

The invention relates in general to a method for encrypting/decrypting documents, and more particularly to a method for encrypting/decrypting by using a scanner to scan particular patterns and documents.

2. Description of the Related Art

Generally speaking, a conventional scanner can only be used to scan documents such as texts or pictures and store the scanned results in the form of electronic files. If document encryption is required, extra encryption software will be used for encrypting the document. So, using a conventional scanner and conventional encryption method to encrypt documents is not only labor- and time-consuming, but also requires more costs because extra encryption software needs to be procured.

### SUMMARY OF THE INVENTION

It is therefore an object of the invention to provide a method for encrypting/decrypting a document which not only makes document encryption/decryption more labor- and time-saving, but also effectively reduces the cost of document encryption/decryption.

The invention achieves the above-identified object by providing a new method for encrypting/decrypting a document which at least includes the following steps: first, scan a particular pattern and have the particular pattern stored accordingly; next, scan a document; last, encrypt/decrypt the document in accordance with the particular pattern scanned. Of which, the step of scanning a compensating color panel can be further included prior to the step of scanning a particular pattern. Moreover, a decision regarding whether to encrypt/decrypt a document or not can be added prior to the step of scanning a particular pattern: if yes, proceed to the step of scanning a particular pattern, otherwise, scan the document and end the method of document encryption/decryption. The step of scanning a compensating color panel can be further added prior to the step of determining whether to encrypt/decrypt the document or not.

It is another object of the invention to provide a method for authenticating a document which at least includes the following steps: first, scan a particular pattern and have the particular pattern stored accordingly; next, scan a document; last, authenticate the document in accordance with the particular pattern scanned. Of which, the step of scanning a compensating color panel can be further included prior to the step of scanning a particular pattern. Moreover, a decision regarding whether to authenticate a document or not can be added prior to the step of scanning a particular pattern: if yes, proceed to the step of scanning a particular pattern, otherwise, scan the document and end the method of document authentication. The step of scanning a compensating color panel can be further added prior to the step of determining whether to authenticate the document or not.

It is another object of the invention to provide a method for activating a particular function of a scanner which at least includes the following steps: first, scan a particular pattern; next, store the particular pattern scanned; last, verify the scanner in accordance with the particular pattern scanned: if the verification is approved, activate the particular function of the scanner, otherwise, the scan module of the scanner returns for homing. Of which, the step of scanning a compensating color panel can be further included prior to the step of scanning a particular pattern. Moreover, a decision regarding whether to activate the particular function of the scanner or not can be added prior to the step of scanning a particular pattern: if yes, proceed to the step of activating a particular function of a scanner, otherwise, scan the document and end the method for activating a particular function of a scanner. The step of scanning a compensating color panel can be further added prior to the step of determining whether to activate the particular function of the scanner or not.

Other objects, features, and advantages of the invention will become apparent from the following detailed description of the embodiments. The following description is made with reference to the accompanying drawings.

### BRIEF DESCRIPTION OF THE DRAWINGS

FIG. 1 is a schematic diagram of an encrypted compensating color panel according to a method disclosed in an embodiment of the invention;

FIG. 2 is a flowchart of a method for encrypting a document according to first embodiment of the invention;

FIG. 3 is a flowchart of a method for authenticating a document according to second embodiment of the invention;

FIG. 4 is a flowchart of a method for activating a particular function of a scanner according to third embodiment of the invention;

FIG. 5 a flowchart of another method for activating a particular function of a scanner; and

FIG. 6 is a schematic diagram of a scanner according to the embodiments of the invention.

### DETAILED DESCRIPTION OF THE INVENTION

The invention is elaborated by means of the embodiments. However, these embodiments do not limit the scope of the invention, but rather, they serve to explain a method for encrypting/decrypting a document in accordance with the spirit of the invention. The features of the technology of the invention are detailed below.

Due to some factors such as lamps, optical paths, and electric charge coupling elements, an ordinary flat scanner always produces an uneven distribution of signals between the middle part of the scan range and its two sides. To calibrate such uneven distribution of signals, a piece of compensating color panel slightly larger than the width of the document is pasted onto the inner side of the upper cover of the scanner. The compensating color panel is even standard white.

The compensating color panel is for calibrating the scanned results of the document. Prior to scanning a document, the scan module will scan the compensating color panel first. The scan module will then process the data of the scanned results of the document in accordance with the data of the scanned results of the compensating color panel, such that the signals of the scanned document can meet expected results.

First Embodiment:

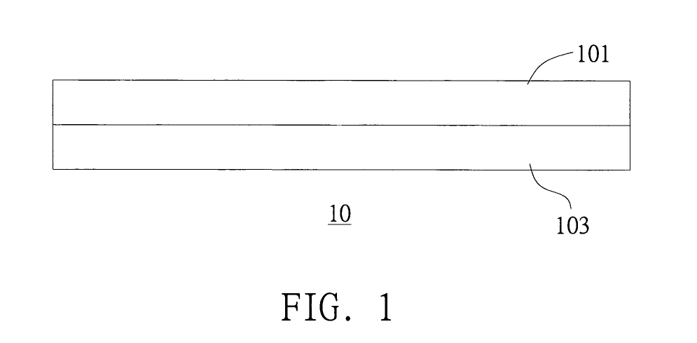

Referring to FIG. 1, a schematic diagram of an encrypted compensating color panel according to a method disclosed in an embodiment of the invention is shown. Encrypted compensating color panel 10 mainly includes a compensating color panel 101 and a particular pattern 103, a bar code pattern for example. The encrypted compensating color panel 10, which is slightly larger than the width of the document, is pasted onto the inner side of the upper cover of the scanner and is within the scan range of the scan module.

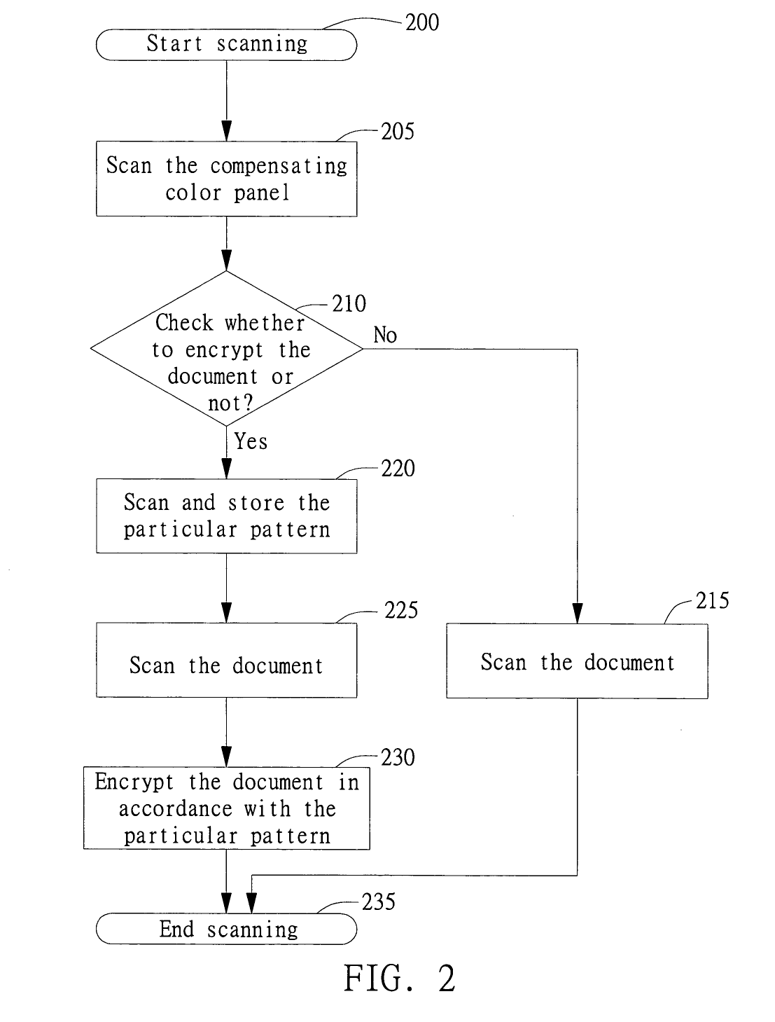

Referring to FIG. 2, a flowchart of a method for encrypting a document according to the first embodiment of the invention is shown. The method of the invention for encrypting a document mainly includes the following steps. First, start with step 200: the scanner starts to scan. Next, proceed to step 205: use the scan module of the scanner to scan a compensating color panel 101 disposed on the encrypted compensating color panel 10 shown in FIG. 1. After that, proceed to step 210: determine whether to encrypt a document or not. If not, proceed to step 215 where the scan module is used to scan the document directly, then proceed to step 235 to end document scanning. The method of document encryption ends here.

Otherwise, if the decision is to encrypt the document, then proceed to step 220 where the scan module scans a particular pattern 103 disposed under the compensating color panel 101, converts the particular pattern 103 into particular pattern signals and has these particular pattern signals stored in the scanner. Following that, proceed to step 225 where the scan module scans the document, then proceed to step 230 where the scanner encrypts the document scanned by the scan module in accordance with the particular pattern signals of the particular pattern 103. Last, proceed to step 235: the scanner ends scanning.

In step 205 of the above embodiment where a scan module is used to scan the compensating color panel 101 (FIG. 1) is a step normally performed before the scanner starts to scan the document. The particular pattern 103, a bar code pattern for instance, can combine with the compensating color panel 101 to form the encrypted compensating color panel 10, so that after scanning the compensating color panel 101, the scan module can easily continue to scan the particular pattern 103.

Particular pattern 103 is scanned and converted into particular pattern signals, wherein these particular pattern signals are exactly a set of cipher codes for encrypting a document. If a document is to be decrypted, the same steps disclosed in the above embodiment are repeated with encryption being replaced with decryption.

After scanning a document, the scanner can give document signals and particular pattern signals special treatment, the superposition of the two signals for instance, so that the superposed output of the scanned document will be different from the original scanned document, thereby completing document encryption. If the encrypted document is to be decrypted, the user only needs to use the scanner to separate document signals from the superposed signals, so the output of the scanned document will have the same content with the original scanned document.

Different scanners can have different particular patterns. In other words, the cipher codes will differ from one scanner to another. The advantage of this practice is that only the same scanner which encrypted a document can have the encrypted document be decrypted.

The key spirit of the embodiment one lies in using the particular pattern 103 to encrypt/decrypt a document scanned by a scanner, thus the present embodiment does not require step 205 to be performed before step 220. That is to say, in the wake of step 200, step 210 can be performed with the omission of step 205; furthermore, even step 210 can be omitted as well, so step 220 can be performed directly.

The above disclosed method of using a scan module to scan the particular pattern 103 and obtain a set of cipher codes of encryption/decryption to encrypt/decrypt a scanned document can have other applications which further enhance the function of the scanner. The next two embodiments are based on the same principles used in present embodiment.

Second Embodiment:

The principles used in the first embodiment can also be used to examine if a scanned document has been encrypted or not. That is to say, if the scanned document is found to be with the encryption of the same particular scanner, then the scanned document is authentic. On the other hand, if the scanned document is found to be without the encryption of the same particular scanner or with both the encryption and the decryption of the same particular scanner, then the scanned document is spurious.

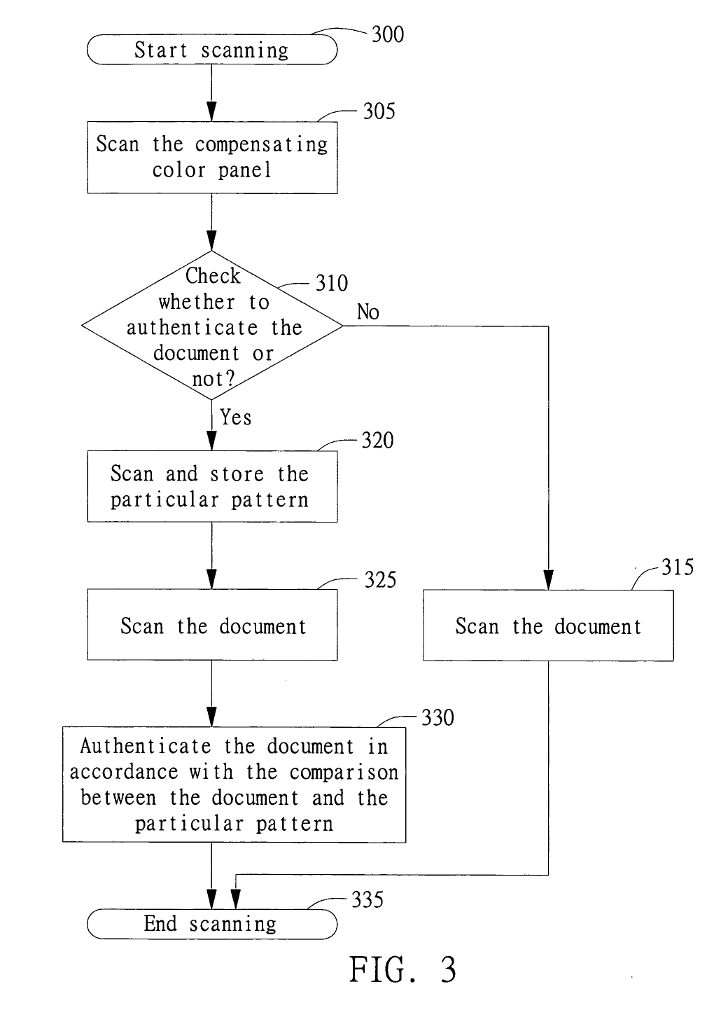

Referring to FIG. 3, a flowchart of a method for authenticating a document according to second embodiment of the invention is shown. The method of the invention for authenticating a document mainly includes the following steps: First of all, start with step 300: the scanner starts to scan. Next, proceed to step 305 whose procedure is the same with that of step 205, i.e., use the scan module of the scanner to scan a compensating color panel 101 disposed on the encrypted compensating color panel 10 shown in FIG. 1. After that, proceed to step 310 to decide whether to authenticate the document. If the decision is not to authenticate the document, then proceed to step 315 where the scan module scans the document directly. Following that, proceed to step 335 to end document scanning. The method of authentication ends here.

If the decision is to authenticate the document, then proceed to step 320 where the scan module scans a particular pattern 103 disposed under the compensating color panel 101, converts the particular pattern 103 into particular pattern signals and has these particular pattern signals stored in the scanner. Following that, proceed to step 325 where the scan module scans the document, then proceed to step 330 where the scanner authenticates the document scanned by the scan module in accordance with the particular pattern signals of the particular pattern 103. Last, proceed to step 235: the scanning ends.

Similarly, the key spirit of the second embodiment lies in using the particular pattern 103 to authenticate a document scanned by a scanner, thus the present embodiment does not require step 305 to be performed before step 320. That is to say, in the wake of step 300, step 310 can be performed with the omission of step 305; furthermore, even step 310 can be omitted as well, so step 320 can be performed directly.

The two embodiments disclosed above use a scan module to scan a particular pattern first to obtain particular pattern signals which are used as a set of cipher codes, then scan a document afterwards. At last, the scanner authenticates the document by using the comparison between document signals and particular pattern signals to determine if the two sets of signals are the same.

Another embodiment disclosed below also uses the principle of scanning the particular pattern 103 to equip the scanner with better functions.

Third Embodiment:

Generally speaking, scanner manufacturers equip the scanner with different functions in accordance with clients' different needs. As a consequence, the functions installed in a scanner must be classified in accordance with clients' different needs, leading to more complexities during function classification process and function packaging.

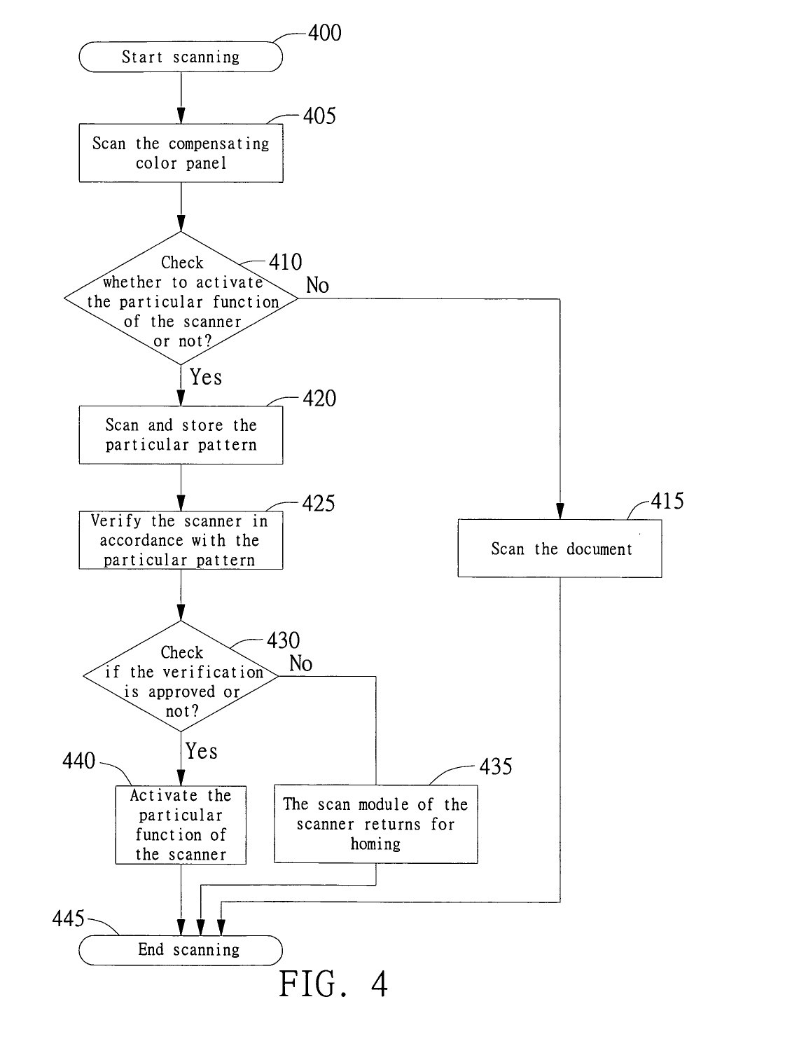

Referring to FIG. 4, a flowchart of a method for activating a particular function of a scanner according to the third embodiment of the invention is shown. The method for activating a particular function of a scanner mainly includes the following steps: First of all, start with step 400: the scanner starts to scan. Next, proceed to step 405: use the scan module of the scanner to scan a compensating color panel 101 disposed on the encrypted compensating color panel 10 shown in FIG. 1. After that, proceed to step 410 to decide whether to activate a particular function. If the decision is not to activate the particular function, then proceed to step 415 where the scan module scans the document directly. Following that, proceed to step 445 to end document scanning. The method for activating a particular function ends here.

If the decision is to activate a particular function, then proceed to step 420 where the scan module scans a particular pattern 103 disposed under the compensating color panel 101, converts the particular pattern 103 into particular pattern signals and has these particular pattern signals stored in the scanner. Following that, proceed to step 425 where the scanner is verified in accordance with the particular pattern signals of the particular pattern 103, then proceed to step 430 where the scanner decides if the verification is approved or not. If the verification is disapproved, the scanner returns for homing, then proceed to step 445 where the scanner ends scanning; if the verification is approved, proceed to step 440 where the particular function of the scanner can be activated, then proceed to step 445 to end scanning.

Similarly, the key spirit of the third embodiment lies in using the particular pattern 103 to activate a particular function of a scanner, thus the present embodiment does not require step 405 to be performed before step 420. That is to say, in the wake of step 400, step 410 can be performed with the omission of step 405; furthermore, even step 410 can be omitted as well, so step 420 can be performed directly.

The activation of a particular function of a scanner disclosed above is determined according to whether the verification of particular pattern signals is approved or not. These particular pattern signals, which are exactly a set of cipher codes, are obtained by scanning the particular pattern 103 and further having these signals stored in the scanner and converted into particular pattern signals.

It can be seen in the above embodiment that the method for activating a particular function can be incorporated with a scanner which has had all functions installed already. The scanner manufacturer only needs to give the user different cipher codes to activate different functions with, thus the complexities during function packaging in the front end manufacturing process can be largely reduced.

Another Application of Third Embodiment:

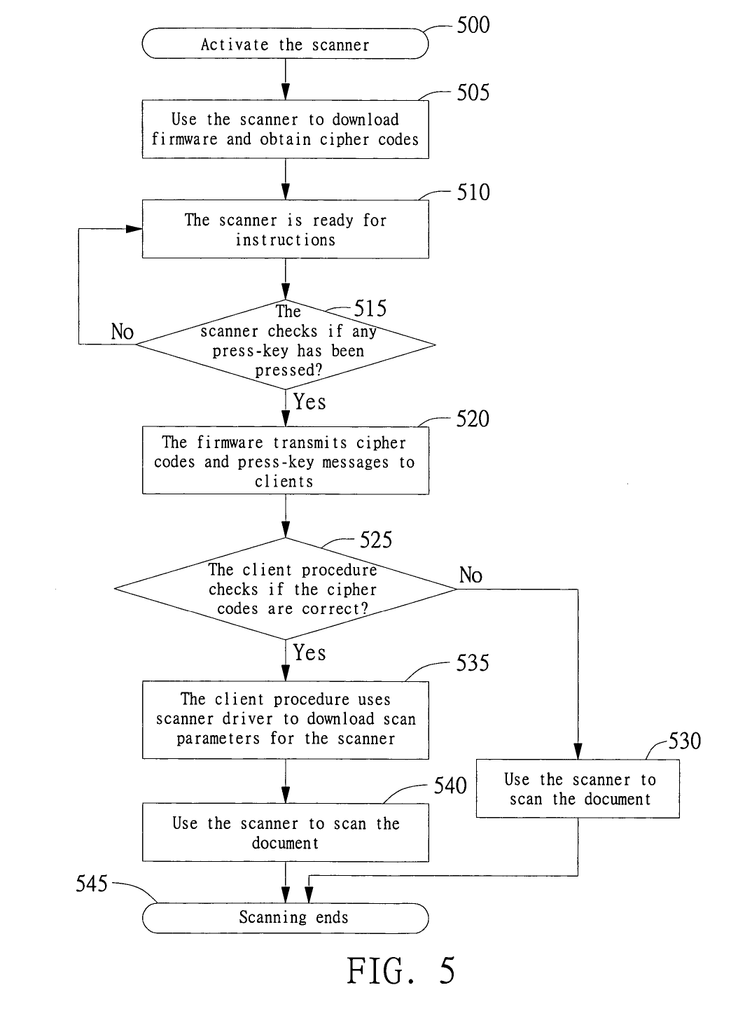

Regarding the third embodiment, another application is detailed below. Referring to FIG. 5, a flowchart of another method for activating a particular function of a scanner is shown. The method for activating a particular function of a scanner mainly includes the following steps: First of all, start with step 500: activate the scanner. Next, proceed to step 505: the scanner automatically download a firmware and obtain a set of cipher codes by using a scan module to scan a particular pattern. After that, proceed to step 510 where the scanner is ready for further instructions. Then, proceed to step 515 where the scanner determines if any key has been pressed or not: if not, return to step 510 and the scanner remains waiting, if yes, proceed to step 520 where the firmware sends cipher codes and press-key messages to a client procedure.

Following step 520, proceed to step 525 where the client procedure verifies if the cipher codes are correct. If the cipher codes are incorrect, the scanner can either scan the document in an ordinary way without activating any special function before proceeding to step 545 where the scanner ends scanning, or proceed to step 545 directly without scanning the document at all. The so-called ‘client procedure’ is a software incorporating several functions such as pattern scanning, text identification and data transmission. The client procedure can use the scanner driver to perform special-function scanning. So, if the client procedure is verified to be correct in step 525, proceed to step 535 where the client procedure uses the scanner driver to download scan parameters of special-function scanning for the scanner.

Next, proceed to step 540: the scanner perform special-function scanning in accordance with these scan parameters. For example, when scanning a check, the resolution level in pattern recognition is particularly important. By means of the above method for activating a particular function of a scanner, the manufacturer can provide the user with special function as required. Last, proceed to step 545 to end the scanning.

The above step 505 of downloading firmware and obtaining cipher codes is equivalent to step 420 in the third embodiment, while the above step 525 where the client procedure verifies the cipher codes is equivalent to step 425 and step 430 in the third embodiment. The cipher codes that the scanner retrieves from the firmware is equivalent to the particular pattern signals obtained by using the scan module to scan a particular pattern.

It can be seen from the above disclosure that while different user may have different needs, the user can use the client procedure to verify the cipher codes retrieved from the firmware to achieve the desired special functions.

Scanner According to the Embodiments of the Invention:

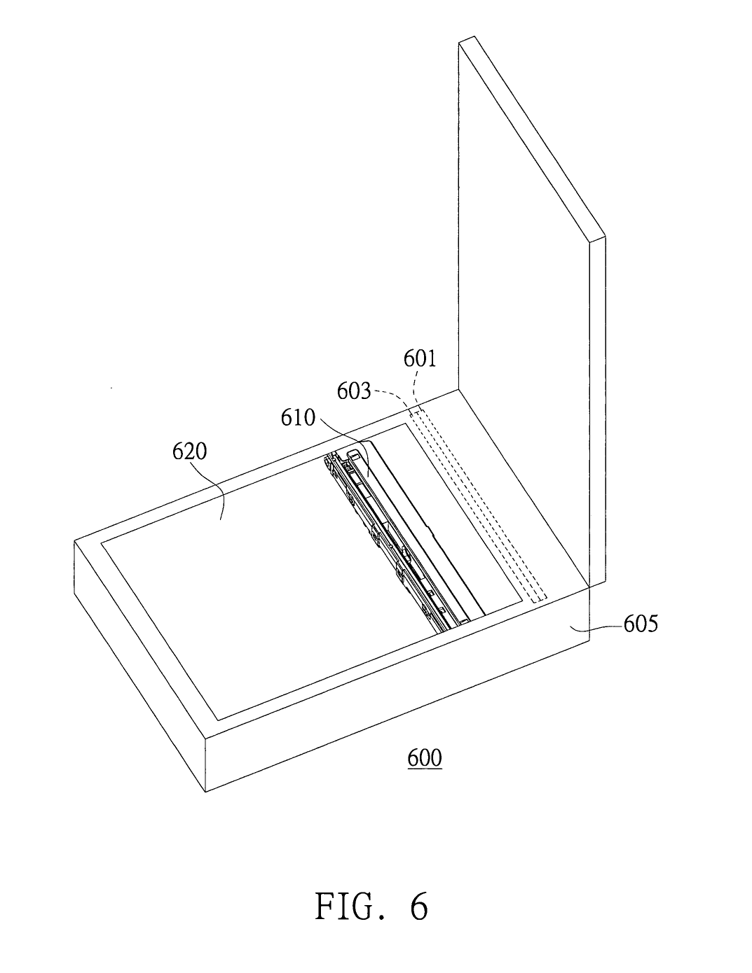

Referring to FIG. 6, a schematic diagram of a scanner according to the embodiments of the invention is shown. Scanner 600 according to the invention mainly includes a casing 650, a scan module 610 and a particular pattern panel 603, wherein the scan module 610 can be installed inside the casing 605 in a movable way, while the particular pattern 603 is disposed on the casing 605. In the above embodiment, the particular pattern of the particular pattern panel 603 which can be used as a set of cipher codes is disposed inside the scanner 600 in a position near to a compensating color panel 601 for instance. Anyone who is familiar with the technology of the invention can infer from the above disclosure that the disposition of the particular pattern panel 603 does not necessarily have to be limited to near the compensating color panel 601: anywhere that is within the scan range of the scan module 610 will do. Furthermore, the particular pattern panel 603 can be treated as a document to be scanned and does not need to be disposed inside the scanner 600. When encryption/decryption or other special-function scanning is needed, before scanning actually starts, the particular pattern panel 603 will be placed on a scan platform 620 to be scanned first. The scanned results will be used as a set of cipher codes for encrypting/decrypting the document or as a basis of judgment to decide whether the corresponding special function should be activated or not. Comparing with the conventional method which requires extra software to encrypt/decrypt a document, the embodiments according to the invention disclosed above have several advantages. The invention pastes a piece of encrypted compensating color panel including a compensating color panel and a particular pattern onto a scanner and calibrates the scanner accordingly, so that the encryption function and the decryption function are now incorporated into one and that the user can encrypt/decrypt a document using only one scanner. This not only enhances convenience and improves reliability of an encrypted document, but also reduces costs and equips the scanner with more functions, such as document authentication and the encryption of particular functions.

While the invention has been described by way of example and in terms of an embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method of encrypting/decrypting a document, comprising:
scanning a particular pattern;
storing the particular pattern;
scanning a document; and
encrypting/decrypting the document in accordance with the particular pattern.

2. The method of encrypting/decrypting a document according to claim 1, wherein prior to the step of scanning the particular pattern, a step of scanning a compensating color panel is further comprised.

3. The method of encrypting/decrypting a document according to claim 1, wherein prior to the step of scanning the particular pattern, a step of determining whether to encrypt/decrypt the document is further comprised:
if yes, performing the step of scanning the particular pattern;
else, scanning the document and ending the method of encrypting/decrypting a document.

4. The method of encrypting/decrypting a document according to claim 3, wherein prior to the step of determining whether to encrypt/decrypt the document, a step of scanning a compensating color panel is further comprised.

5. A method of authenticating a document, comprising:
scanning a particular pattern;
storing the particular pattern;
scanning a document; and
authenticating the document in accordance with the comparison between the particular pattern and the document.

6. The method of authenticating a document according to claim 5, wherein prior to the step of scanning the particular pattern, a step of scanning a compensating color panel is further comprised.

7. The method of authenticating a document according to claim 5, wherein prior to the step of scanning the particular pattern, a step of determining whether to authenticate the document is further comprised:
if yes, performing the step of scanning the particular pattern;
else, scanning the document and ending the method of authenticating a document.

8. The method of authenticating a document according to claim 7, wherein prior to the step of determining whether to authenticate the document, a step of scanning a compensating color panel is further comprised.

9. A method of activating a function of a scanner, comprising at lest the step of:
scanning a pattern;
storing the pattern; and
verifying the scanner in accordance with the pattern:
if verified, activating a function of the scanner.

10. The method of activating a function of a scanner according to claim 9, wherein prior to the step of scanning the pattern, a step of scanning a compensating color panel is further comprised.

11. The method of activating a function of a scanner according to claim 9, wherein prior to the step of scanning the pattern, a step of determining whether to activate the function of the scanner is further comprised:
if yes, performing the step of scanning the pattern;
else, scanning the document and ending the method of activating function of a scanner.

12. The method of authenticating activating a function of a scanner according to claim 11, wherein prior to the step of determining whether to activate the function of the scanner, a step of scanning a compensating color panel is further comprised.

13. A scanner, comprising:
a casing;
a scan module which is disposed inside the casing in a movable way; and
a pattern panel disposed on the casing;
wherein the scan module scans the pattern disposed on the particular pattern panel, and the pattern is for encrypting/decrypting a document during scanning or for activating a pre-set function of the scanner.

14. The scanner according to claim 13, further comprises a compensating color panel for calibrating the scan module with, wherein the pattern panel is disposed adjacent to the compensating color panel.

15. The scanner according to claim 13, wherein the pattern panel is disposed on the casing in a removable way.
